(19) United States
(12) Patent Application Publication
(10) Pub. No.: US 2020/0174822 A1
(43) Pub. Date: Jun. 4, 2020

(54) STARTUP METHOD AND APPARATUS FOR VIRTUAL MACHINE, AND SMART TERMINAL

(71) Applicant: CLOUDMINDS (SHENZHEN) ROBOTICS SYSTEMS CO., LTD., Shenzhen (CN)

(72) Inventor: Yangang LI, Shenzhen (CN)

(21) Appl. No.: 16/784,809

(22) Filed: Feb. 7, 2020

Related U.S. Application Data
(63) Continuation of application No. PCT/CN2017/096243, filed on Aug. 7, 2017.

(51) Int. Cl. G06F 9/455

(52) U.S. Cl. CPC G06F 9/45558; G06F 2009/45575; G06F 9/45545

(57) ABSTRACT

A startup method for a virtual machine includes: at a smart terminal: acquiring a current energy state of the smart terminal in response to an instruction for starting up the virtual machine; configuring a virtual device list for the virtual machine based on the energy state; and loading virtual devices in the virtual device list to support running of the virtual machine.

### CROSS-REFERENCE TO RELATED APPLICATIONS

This application is a continuation of international Application No. PCT/CN2017/096243 with an international filing date of Aug. 7, 2017, the entire contents of which are incorporated herein by reference.

### TECHNICAL FIELD

The present application relates to the technical field of cloud computing, and in particular, relates to a startup method and apparatus for a virtual machine, and a smart terminal.

### BACKGROUND

In the technical field of cloud computing, with constant growth of hardware cost, the virtualization technology represented by virtual machines are in drastically development because of low cost, high security and the like merits, At present, before a virtual machine in a smart terminal is started up, a virtual device list supporting running of the virtual machine needs to be configured, and device parameters and the like information of each virtual device need to be configured in this list. Upon receiving an instruction for starting up the virtual machine from a user, the smart terminal loads all the virtual devices in the virtual device list to support running of the virtual machine. When running of the virtual device needs support from a rear-end device, the corresponding rear-end device also needs to be started up.

However, the inventors have identified that the related art has at least the following problem: in the related art, the configured virtual device list is constantly unchanged, and may not be adjusted based on a current energy state of the smart terminal. If the smart terminal still loads all virtual devices to run the virtual machine in an energy shrinking state, it is easy to cause unnecessary energy loss.

### SUMMARY

An embodiment of the present application provides a startup method for a virtual machine. The method includes: at a smart terminal: acquiring a current energy state of the smart terminal in response to an instruction for starting up the virtual machine; configuring a virtual device list for the virtual machine based on the energy state; and loading virtual devices in the virtual device list to support running of the virtual machine.

Another embodiment of the present application provides a smart terminal. The smart terminal includes: at least one processor; and a memory communicably connected to the at least one processor; wherein the memory stores instructions executable by the at least one processor, wherein, the instructions, when being executed by the at least one processor, cause the at least one processor to perform the steps of: acquiring a current energy state of the smart terminal in response to an instruction for starting up the virtual machine; configuring a virtual device list for the virtual machine based on the energy state; and loading virtual devices in the virtual device list to support running of the virtual machine.

Still another embodiment of the present application provides a non-transitory computer-readable storage medium. The non-transitory computer-readable storage medium stores computer-executable instructions, which, when being executed by a smart terminal, cause the smart terminal to perform the steps of: acquiring a current energy state of the smart terminal in response to an instruction for starting up the virtual machine; configuring a virtual device list for the virtual machine based on the energy state; and loading virtual devices in the virtual device list to support running of the virtual machine.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic diagram of an application environment of a startup method for a virtual machine according to an embodiment of the present application;

FIG. 2 is a schematic flowchart of a startup method for a virtual machine according to an embodiment of the present application;

FIG. 3 is a schematic flowchart of another startup method for a virtual machine according to an embodiment of the present application;

FIG. 4 is a schematic structural diagram of a startup apparatus for a virtual machine according to an embodiment of the present application; and

FIG. 5 is a schematic structural diagram illustrating hardware of a smart terminal according to an embodiment of the present application.

### DETAILED DESCRIPTION

For clearer descriptions of the objectives, technical solutions, and advantages of the present application, the present application is further described with reference to specific embodiments and attached drawings. It should be understood that the specific embodiments described herein are only intended to explain the present application instead of limiting the present application.

It should be noted that, in the absence of conflict, embodiments of the present application and features in the embodiments may be incorporated, which all fall within the protection scope of the present application. In addition, although logic function module division is illustrated in the schematic diagrams of apparatuses, and logic sequences are illustrated in the flowcharts, in some occasions, steps illustrated or described by using modules different from the module division in the schematic diagrams of the apparatuses or in sequences different from those illustrated.

A startup method for a virtual machine according to the embodiments of the present application is a method in which a smart terminal configures a virtual device list for the virtual machine to be started based on a current energy state, and hence starts up the virtual machine based on the configured virtual device list. This method may be applied to any type of smart terminals, for example, a robot, a smart phone, a server, a personal computer, a tablet computer, a wearable smart device, a smart home appliance or the like. The startup method for the virtual machine according to the embodiments of the present application saves entire energy consumptions of the smart terminal, and ensures that the smart terminal still supports running of the virtual machine in an energy shrinking state.

Hereinafter, the embodiments of the present application are further illustrated with reference to the accompanying drawings.

FIG. 1 is a schematic diagram of an application environment of a startup method for a virtual machine according to an embodiment of the present application. The application environment may be a computer system environment running on a smart terminal, Specifically, as illustrated in FIG. 1, the application environment includes: a physical hardware device 10, a host operating system 10 and a plurality of guest operating systems 12.

The physical hardware device 10 is an actually existent hardware device, and may include any suitable device components constituting a complete computer system, including, but not limited to: a processor 101, a storage medium 102, an input/output device 103, a communication module 104, and the like.

Specifically, the processor 101 may be any suitable type of processor having a specific logic operation capability, for example, a central processing unit, a graphics processor or the like. The processor 101 may include a plurality of kernels for use in multiple threads or parallel processing.

The storage medium 102 may include a memory module, for example, a ROM, a RAM, a flash module, and a large-capacity memory, for example, an optical disk and a hard disk. The storage medium 102 stores computer programs, which, when being executed by the processor 101, may perform various corresponding method steps or processes.

The input/output device 103 may be any suitable type of peripheral device that provides one or more user interaction manners, for example, a mouse, a keypad or a touch input screen for receiving a user action operation instruction, a motion sensing video camera, a microphone for acquiring audio information or a display screen for exhibiting image information for a user or a loudspeaker for outputting audios. The input/output device 103 may select to use a wired or wireless peripheral device to connect to another physical hardware device.

The communication module 104 may include some network interface devices that establish a connection via a wired or wireless communication network, for example, a network cable interface, a bus interface, a USB interface, a WiFi module or a Bluetooth communication module or the like.

In practical applications, the physical hardware device 10 may be also added with one or a plurality of devices to accommodate the requirements in different practical applications, for example, a database or a server device is added.

The host operating system 11 and the guest operating system 12 are both computer programs for managing and controlling the physical hardware device 10 and corresponding software resources, and is most basic system software that runs on a “naked” computer, and any other software may run only under support of the host operating system 11 or the guest operating systems 12. In the embodiment of the present application, the host operating system 11 and the guest operating systems 12 may be any suitable type of operating systems, for example, Linux, Unix, iOS, Android, Windows or the like, for receiving a user instruction and outputting and exhibiting a corresponding processing result for the user.

The host operating system 11 and the plurality of guest operating systems 12 share the physical hardware device 10. In practical running, the host operating system 11 may directly use hardware in the physical hardware device, whereas the guest operating systems 12 may use a virtual device provided by the virtual machine driving the guest operating system 12. The “virtual machine” refers to a computer system that is simulated by software, has the functions of a hardware system, and is running in an absolutely isolated environment. The virtual machine may form a plurality of simulated hardware devices (that is, the “virtual devices” in the embodiments of the present application) based on the physical hardware device 10 or other simulated hardware devices for use by the guest operating systems. One virtual machine correspondingly drives one guest operating system. Therefore, it may be considered that if a virtual machine is started up, the guest operating system corresponding to the virtual machine is also started up. Each virtual machine may run as an application in the host operating system 11.

Memory isolation is present between different operating systems. Even the host operating system 11 may not access a memory space of the guest operating system 12. As such, when the computer system includes two or more than two guest operating systems 12, if one of the guest operating systems 12 is re-started up due to an exception, the host operating system 11 and the remaining guest operating systems 12 may still run normally and may be isolated from each other. Nevertheless, since the virtual machine runs as an application in the host operating system, if the host operating system 11 is re-started up due to an exception, all the guest operating systems 12 need to be re-started up before running.

In this embodiment of the present application, when a user needs to open one of the guest operating systems 12 on the smart terminal, the user may input a corresponding instruction in the host operating system 11 to start up the virtual machine for driving the guest operating system 12. For example, the user may click an icon corresponding to the guest operating system or input a command for starting up the guest operating system/virtual machine. Upon receiving an instruction for starting up a virtual machine, the smart terminal may start up the virtual machine by using the startup method for the virtual machine according to this embodiment of the present application. That is, a current energy state of the virtual machine is acquired in response to an instruction for starting up the virtual machine; a virtual device list is configured for the virtual machine based on the energy state; and virtual devices in the virtual device list are loaded to support running of the virtual machine. The loaded virtual devices are virtual devices that are currently provided by the virtual machine for the guest operating system 12. The guest operating system 12 may access resources provided by these virtual devices to perform a particular task upon receiving another operation instruction.

It should be noted that the “virtual device” is a hardware device simulated by software, which may be a virtual hardware device with the functions of hardware that are acquired based on software simulation, or may be a mirror file for calling resources in the corresponding physical hardware device 10. The guest operating system 12 runs on a virtual hardware platform constructed by these virtual devices.

In addition, the startup method for the virtual machine according to this embodiment of the present application may be further applied to other suitable application environments, instead of being limited to the application environment as illustrated in FIG. 1. In practical application, the application environment may also include more and fewer guest operating systems, and more or fewer types of physical hardware devices.

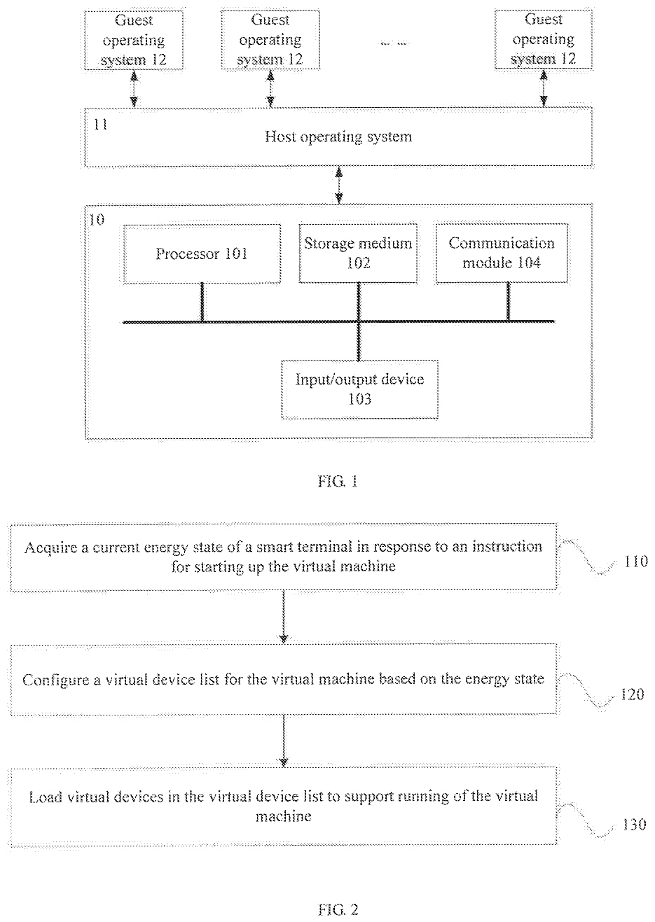

Specifically, FIG. 2 is a schematic flowchart of a startup method for a virtual machine according to an embodiment of the present application. The method may be performed by a mobile phone, a robot, a personal computer, a wearable smart device, a server and the like smart terminal. Referring to FIG. 2, the method includes the following steps:

110: A current energy state of a smart terminal is acquired in response to an instruction for starting up the virtual machine.

In this embodiment, the “energy state” refers to an energy distribution state of the smart terminal, which may include, but not limited to: a total energy of the smart terminal, an energy consumption value of the virtual machines (the guest operating systems), an energy consumption value of the host operating system, energy consumption of the smart terminal within a time period prior to the current time and the like. The energy state may be evaluated based on a power state or a power amount state of the smart terminal. In this embodiment, for more explicit description, the energy state of the smart terminal is evaluated based on the power amount state of the smart terminal.

In this embodiment, when an instruction for starting a virtual machine is received, a current energy state of a smart terminal is firstly acquired. For example, assuming that a computer system running on the smart terminal includes a host operating system, a guest operating system A, a guest operating system B and a guest operating system C, and the guest operating systems A, B and C are respectively driven by virtual machines a, b and c (that is, the guest operating system is driven by the virtual machine a, the guest operating system is driven by the virtual machine h, and the guest operating system C is driven by the virtual machine c). At a time point, if the user desires to open the guest operating system A, the user may click an icon of “virtual machine a” or input a command “start up the virtual machine a” in the host operating system to start up the virtual machine a. In this case, the smart terminal receives an instruction for starting up the virtual machine a, and acquires a current power amount state of the smart terminal in response to the instruction. The power amount state may include: a current total power amount Q of the smart terminal, a power consumption value q0 of the host operating system, a power consumption value q2 of the virtual machine b (the guest operating system B), and a power consumption value q3 of the virtual machine c (the guest operating system C). If the virtual machine b and/or the virtual machine c is in a suspended, the power consumption value q2 and/or power consumption value q3 may be 0.

120: A virtual device list is configured tier the virtual machine based on the energy state.

In this embodiment, the “virtual device” is a hardware device simulated by software, which may be a virtual hardware device with the functions of hardware that are acquired based on software simulation, or may be a mirror file for calling resources in the corresponding physical hardware device. A plurality of virtual devices construct a resource pool. When the virtual machine is being started up, a part or all of the virtual devices are selected from the resource pool and loaded to provide a hardware platform for the guest operating systems. For example, the virtual devices may include, but not limited to: a virtual CPU, a virtual clock, a virtual interrupt manager, a virtual peripheral device and the like. The virtual CPU is a main unit for instruction execution and operation, the virtual clock provides a clock source for such operations as process scheduling and the like for the guest operating systems, the virtual interrupt manager manages interrupt signals generated by the virtual peripheral devices and provided for the CPU, and the virtual peripheral devices are input/output device modules practiced by the virtual machine.

In this embodiment, based on different energy states, the virtual devices needed for starting up the virtual machine are added to the “virtual device list”. These virtual devices to be loaded are used support running of the virtual machine and are for use by the guest operating systems.

In this embodiment, a plurality of startup modes may be configured for the virtual machine based on the available energy value of the virtual machine. In addition, a corresponding relationship between the “available energy value of the virtual machine” and the “startup mode”, and a virtual device list corresponding to each startup mode are predefined in the smart terminal. For example, a high performance mode and an energy shrinking mode may be predefined for the virtual machine. If the available energy value of the virtual machine is greater than or equal to a predefined energy threshold, the virtual machine is started up in the high performance mode; and on the contrary, if the available energy value of the virtual machine is less than the predefined energy threshold, the virtual machine is started up in the energy shrinking mode. In the high performance mode, all the virtual devices supporting running of the virtual machine may be added to the “virtual device list”. Based on this, after the virtual machine is started up, a most complete virtual hardware platform may be provided for the guest operating systems, such that the operation capabilities of the guest operating systems in the high performance mode are most powerful. In the energy shrinking mode, the most fundamental virtual devices maintaining normal running of the virtual machine may only be added to the “virtual device list”. Based on this, after the virtual machine is started up, a virtual hardware platform implementing fundamental functions may only be provided for the guest operating systems, such that the operation capabilities of the guest operating system in the energy shrinking mode are poorest. Accordingly, in this embodiment, specific practice of configuring a virtual device list for the virtual machine based on the energy state may be: determining a startup mode of the virtual machine based on the energy state, and then configuring the virtual device list corresponding to the startup mode for the virtual machine.

It should be noted that, the “available energy value of the virtual machine” refers to a maximum energy value provided by the smart terminal for the virtual machine currently, wherein this value may be determined by analyzing the determined energy state. Further, it should be understood that, in practical application, the startup mode of the virtual machine may not be limited to the high performance mode and the energy shrinking mode. The virtual device list corresponding to each startup mode may also be adjusted based on the actual needs, which is not described herein any further.

For example, assuming that the acquired current energy state of the smart terminal is: the total power amount is Q, the power consumption value of the host operating system is q0, the power consumption value of the virtual machine b (the guest operating system B) is q2, the power consumption value of the virtual machine c (the guest operating system C) is q3, based on the above data, it may be determined that the available power amount of the virtual machine a is q1=Q−q0−q2−q3. After the available power amount q1 of the virtual machine a is determined, the power amount q1 may be compared with the predetermined energy threshold to determine a startup mode corresponding to the power amount q1, and thus a virtual device list is configured for the virtual machine a based on the startup mode and a predefined corresponding relationship between the startup node and the virtual device list.

130: Virtual devices in the virtual device list are loaded to support running of the virtual machine.

In this embodiment, startup of the virtual machine is practiced by loading the virtual devices supporting running of the virtual machine to be started up. Therefore, after the virtual device list is configured for the virtual machine based on the energy state, the virtual devices in the virtual device list are loaded to construct a virtual hardware running platform for the virtual machine to support running of the virtual machine, such that the virtual machine is started up.

It should be noted that, in this embodiment, the “loading” the virtual devices in the virtual device list means that the computer system running on the smart terminal allocates physical hardware resources corresponding to the virtual devices or constructs virtual devices having the functions of a hardware device by means of software. For example, in this embodiment, loading the “virtual CPU” means that the computer system allocates corresponding CPU resources for the virtual machines.

As known from the above technical solutions, this embodiment of the present application achieves the following beneficial effects:

With the startup method for the virtual machine according to this embodiment of the present application, by acquiring a current energy state of a smart terminal in response to an instruction for starting up a virtual machine, configuring a virtual device list for the virtual machine based on the energy state, and loading virtual devices in the virtual device list to support running of the virtual machine, the number and the types of virtual devices to be loaded may be determined based on the current energy state of the smart terminal, energy consumptions caused by loading excessive or large-energy-consuming virtual devices when the energy of the smart terminal shrinks, and the smart terminal is ensured to still support running of the smart terminal in an energy shrinking state.

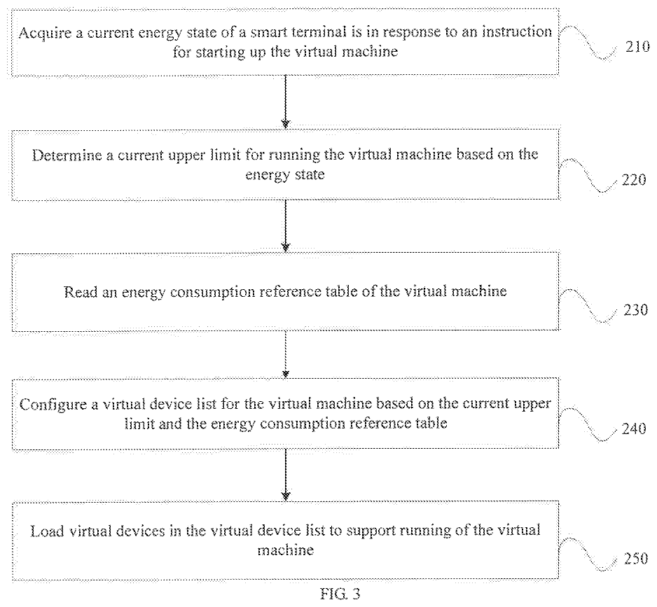

FIG. 3 is a schematic flowchart of another startup method for a virtual machine according to an embodiment of the present application. Referring to FIG. 3, the method includes the following steps:

210: current energy state of a smart terminal is acquired in response to an instruction for starting up the virtual machine.

220: A current upper limit for running the virtual machine is determined based on the energy state.

In this embodiment, the “current upper limit” refers to a maximum current value provided by the smart terminal for the virtual machine currently, which is correlated to the total energy provided by the smart terminal for the virtual machine.

Therefore, in this embodiment, an available enemy value of the virtual machine may be firstly determined by analyzing the current energy state of the smart terminal, and hence the current upper limit Iₜₒₜ for running the virtual machine may be determined based on the available energy value of the virtual machine.

Specific practice of determining the available energy value of the virtual machine by analyzing the current energy state of the smart terminal may be referenced to step 120 in the above embodiment, which is thus not described herein any further.

Specific practice of determining the current upper limit Iₜₒₜ for running the virtual machine based on the available enemy value of the virtual machine may be: predefining a corresponding relationship between the available energy value of the virtual machine and the current upper limit Iₜₒₜ, and hence determining the current upper limit Iₜₒₜ for running the virtual machine based on the corresponding relationship after the available energy value of the virtual machine is determined.

Alternatively, in some embodiments, the specific practice of determining the current upper limit Iₜₒₜ for running the virtual machine based on the available energy value of the virtual machine may also be: receiving a running time t of the virtual machine, and determining the current upper limit Iₜₒₜ for running the virtual machine based on the available energy value q1 of the virtual machine and the running time t. The running time t may be a default value defined by the smart terminal based on the current energy state, or may be a value determined based on an input by the user. For example, when starting up the virtual machine a, the user may input the running time t in an interface for starting up the virtual machine a (or the user selects a startup mode in the interface for starting up the virtual machine a, and the smart terminal matches the running time t for the virtual machine based on the startup mode), In this case, after the available energy value q1 of the virtual machine a is determined based on the current energy state of the smart terminal, it may be determined that the current upper limit Iₜₒₜ for running the virtual machine a is equal to q1/t. In this embodiment, by determining the current upper limit for running the virtual machine based on the received running time and available energy value of the virtual machine, the virtual machine may be flexibly started up based on the current energy state of the smart terminal. If the received running time is determined based on the input by the user, the user may conveniently adjust the manner for starting up the virtual machine based on the actual needs. For example, if the user desires to start up the virtual machine in an energy saving mode, a longer running time may be defined, and in this case, the current upper limit for running the virtual machine is smaller, such that only a few of virtual devices may be loaded; and if the user desires to start up the virtual machine in a performance mode, a shorter running time may be defined, and in this case, the current upper limit for running the virtual machine is greater, such that more virtual devices may be loaded.

230: An energy consumption reference table of the virtual machine is read.

In this embodiment, an energy consumption reference table is formulated in advance based on energy consumption values of all the virtual devices supporting running of the virtual machine and an association relationship between the virtual devices. As listed in Table 1, the energy consumption reference table may include types of virtual machines, serial numbers, names, current consumption values, depending devices and the like information of all the virtual devices supporting running of the virtual machine.

TABLE 1
Energy consumption reference table

| | Serial | | | |
|---|---|---|---|---|
| Types of | numbers of | Names of | Current | |
| virtual | virtual | virtual | consumption | Depending |
| devices | devices | devices | values | devices |
| Fundamental | D1 | N1 | I1 | None |
| virtual device | | | | |
| Fundamental | D2 | N2 | I2 | None |
| virtual device | | | | |
| Functional | D3 | N3 | I3 | D1, D2 |
| virtual device | | | | |
| Functional | D4 | N4 | I4 | D1, D2, D3 |
| virtual device | | | | |
| Fundamental | D5 | N5 | I5 | None |
| virtual device | | | | |
| . . . | . . . | . . . | . . . | . . . |
| . . . | Dn | Nn | In | . . . |

The “types of virtual devices” include fundamental virtual devices and functional virtual devices. The virtual devices in the type of fundamental virtual devices are virtual devices that are mandatory for running the virtual machine, for example, a virtual CPU, a virtual clock, a virtual terminal manager and the like; whereas the virtual devices in the type of functional virtual devices are virtual devices that provide virtual hardware environments for implementing particular functions, for example, a virtual camera, a virtual sensor and the like, wherein the virtual machine is capable of running normally even if these functional virtual devices are not loaded.

The “current consumption values” refer to an average current value when the virtual devices are running. The current consumption value of each virtual device may be different from that of another, for example, I1<I2<I2<I5<I4<I3.

The “depending devices” refer to other virtual machines that need to be run for running one virtual device. For example, as listed in Table 1, the depending devices of the virtual device D2 include the virtual device D1 and the virtual device D2. In this case, if the function of the virtual device D3 needs to be implemented, the virtual device D2 and the virtual device D3 need to be simultaneously run. Likewise, if the function of the virtual device D4 needs to be implemented, the virtual device D1, the virtual device D2 and the virtual device D3 need to be simultaneously run.

In addition, for the sake that the generated energy consumption reference table is of more reference significance, and the current consumption value of each virtual device is accurately recorded, in some embodiments, an energy consumption of each virtual device in the running of the virtual machine is statistically collected, and the energy consumption reference table is updated based on the energy consumptions. The “energy consumptions” may include a current value of each virtual device in running at each time point, and an average current value of the virtual device in this running process may be acquired based on the energy consumption. Accordingly, the energy consumption reference table may be updated based on the average current values in this running process. For example, assuming that during this startup process, the virtual devices supporting running of the virtual machine a include the virtual device D1, the virtual device D2, the virtual device D3 and the virtual device D4, through statistical collection, in this running process, the average current values of the virtual devices D1, D2, D3 and D4 may be I1′, I2′, I3′ and I4′ respectively, then the current consumption values of the virtual devices D1, D2, D3 and D4 may be updated to (I1−I1′)/2, (I2+I2′)/2, (I3+I3′)/2 and (I4+I4′)/2 respectively in the energy consumption reference table.

240: A virtual device list is configured for the virtual machine based on the current upper limit and the energy consumption reference table.

In this embodiment, a virtual device list is configured for the virtual machine based on the current upper limit determined based on the current energy state of the smart terminal, and the energy consumption reference table. Specifically, after the current upper limit for running the virtual machine is determined, whether the current upper limit is greater than or equal to a sum of current consumption values of all the virtual devices in the energy consumption reference table is judged. That is, whether the energy currently provided by the smart terminal for the virtual machine is sufficient to support running of all the virtual devices of the virtual machine is judged. If the energy is sufficient to support running of all the virtual devices of the virtual machine (that is, Iₜₒₜ≥I1+I2+I3+I4+I5+ . . . +In), all the virtual devices in the reference consumption reference table may construct the virtual device list (that is, all the virtual devices D1, D2, D3, D5, D5, . . . , Dn may be added to the virtual device list of the virtual machine); and if the energy is not sufficient to support running of all the virtual devices of the virtual machine (that Iₜₒₜ<I1+I2+I3+I4+I5+ . . . +In), the virtual devices having a minimum current consumption value are removed in sequence from the energy consumption reference table, until a sum of current consumption values of the remaining virtual devices in the energy consumption reference table is less than or equal to the current upper limit or the remaining virtual devices in the energy consumption reference table are all fundamental virtual devices, such that the virtual device list is generated.

In addition, to accommodate the actual use needs of the user, in some embodiments, when the user starts up a virtual machine, the user may select some particular virtual devices. For example, the user may add his or her desired functions when starting up the virtual machine, and in this case, the instruction for starting up the virtual machine received by the smart terminal includes an instruction for starting up the particular virtual device. The “particular virtual device” may be a hardware device for implementing the function desired by the user, and one or more particular virtual devices may be selected. Accordingly, in this embodiment, after the virtual device list is configured for the virtual machine based on the current upper limit and the energy consumption reference table, whether the particular virtual device is in the generated virtual device list is further judged. If the particular virtual device is not in the virtual device list, the particular virtual device is added to the virtual device list. Alternatively, feedback information may also be generated for a particular virtual device that is not in the virtual device list and provided for the user, such that user may select whether to still use this function. If the user selects to use this function, the particular virtual device is added to the virtual device list; and otherwise, the generated virtual device list is not modified or the virtual machine is not started up.

250: Virtual devices in the virtual device list are loaded to support running of the virtual machine.

In this embodiment, steps 210 and 250 have the same technical features with steps 110 and 130 as illustrated in FIG. 2, and specific practice thereof also applies to this embodiment, which is thus not described in this embodiment any further.

In addition, it should be understood that, in this embodiment, the current upper limit and the current consumption value of each virtual device are used as standards for configuring the virtual device list for the virtual machine, which is only intended to illustrate this embodiment of the present application instead of limiting this embodiment of the present application. In practical application, other parameters, for example, a voltage value, may also be acquired from the current energy state of the smart terminal, and used as the standards for configuring the virtual device list for the virtual machine.

As known from the above technical solutions, this embodiment of the present application achieves the following beneficial effects:

With the startup method for the virtual machine according to this embodiment of the present application, by acquiring a current energy state of a smart terminal in response to an instruction for starting up a virtual machine, configuring a virtual device list for the virtual machine based on the energy state, and loading virtual devices in the virtual device list to support running of the virtual machine, the number and the types of virtual devices to be loaded may be determined based on the current energy state of the smart terminal, energy consumptions caused by loading excessive or large-energy-consuming virtual devices when the energy of the smart terminal shrinks, and the smart terminal is ensured to still support running of the smart terminal in an energy shrinking state. In addition, in this embodiment, the process of configuring a virtual device list for the virtual machine based on the current energy state of the smart terminal is more flexible, and the virtual device list may be adaptively adjusted in consideration of the actual needs of the user, thereby improving user experience.

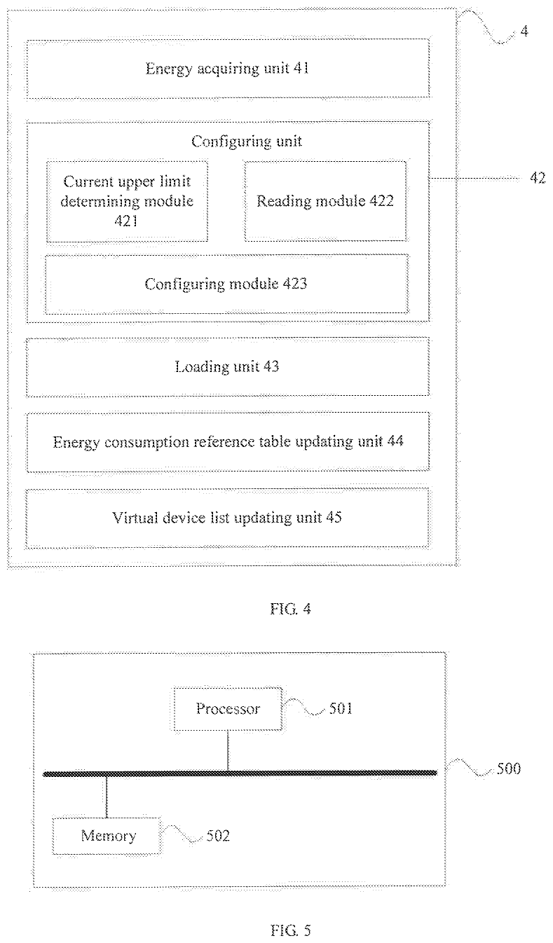

FIG. 4 is a schematic structural diagram of a startup apparatus 4 for a virtual machine according to an embodiment of the present application. Referring to FIG. 4, the apparatus 4 includes:

an energy acquiring unit 41, operable to acquire a current energy state of a smart terminal in response to an instruction for starting up the virtual machine;

a configuring module 42, operable to configure a virtual device list for the virtual machine based on the energy state; and

a loading unit 43, operable to load virtual devices in the virtual device list to support running of the virtual machine.

In this embodiment of the present application, upon receiving an instruction for starting up the virtual machine, the energy acquiring unit 41 acquires a current energy state of a smart terminal in response to the instruction for starting the virtual machine; the configuring unit 42 configures a virtual device list for the virtual machine based on the energy state; and finally, the loading unit 43 loads virtual devices in the virtual device list to support running of the virtual machine.

In another embodiment, the configuring unit 42 is specifically operable to determine a startup mode of the virtual machine based on the energy state, and configure a virtual device list corresponding to the startup mode for the virtual machine. In this embodiment, by configuring different startup modes for the virtual machine, matching a corresponding startup mode based on the current energy state of the smart terminal, and hence configuring a virtual device list for the virtual machine based on the matched startup mode, the smart terminal may conveniently and directly start the virtual machine in the startup mode matching the current energy state, such that a data processing amount in the startup process of the virtual machine is reduced, and a speed of starting up the virtual machine is improved.

In still another embodiment, the configuring unit 42 specifically includes a current upper limit determining module 421, a reading module 422 and a configuring module 423. In this embodiment, the current upper limit determining module 421 determines a current upper limit of the virtual machine based on the energy state, the reading module 422 reads an energy consumption reference table of the virtual machine, and the configuring module 423 configures the virtual device list for the virtual machine based on the current upper limit and the energy consumption reference table, such that the virtual machine list may be flexibly configured for the virtual machine based on the current energy state of the smart terminal, and the virtual device list may be adaptively adjusted in consideration of the actual needs of the user, thereby improving user experience. Virtual devices in the energy consumption reference table include functional virtual devices and fundamental virtual devices. The configuring module 423 is specifically operable to: judge whether the current upper limit is greater than or equal to a sum of current consumption values of all the virtual devices in the energy consumption reference table; generate the virtual device list with all the virtual devices in the energy consumption reference table if the current upper limit is greater than or equal to the sum of current consumption values of all the virtual devices in the energy consumption reference table; and otherwise, remove functional virtual devices with a minimum current consumption value in the energy consumption reference table in sequence, until a sum of current consumption values of the remaining virtual devices in the energy consumption reference table is less than or equal to the current upper limit or the remaining virtual devices in the energy consumption reference table are all fundamental virtual devices, such that the virtual device list is generated.

In some embodiments, the apparatus 4 further includes:

an energy consumption reference table updating unit 44, operable to collect statistics for energy consumptions of the virtual devices in the process of running the virtual machine, and update the energy consumption reference table based on the energy consumptions. In this embodiment, the energy consumption reference table updating unit 44 updates the energy consumption reference table, such that accuracy of the energy consumption reference table of the virtual machine is improved.

In some embodiments, when the instruction for starting up the virtual machine includes an instruction for starting up a particular virtual device, the apparatus 4 further includes:

a virtual device list updating unit 45, operable to add the particular virtual device to the virtual device list if the particular virtual device is not in the virtual device list. In this embodiment, the virtual device list updating unit 45 updates the generated virtual device list based on an instruction input by the user for starting up the particular virtual machine, such that the virtual machine may be started up based on the actual needs of the user.

It should be noted that since the startup apparatus for the virtual machine and the startup method for the virtual machine are based on the same inventive concept, corresponding content disclosed the above method embodiments and the beneficial effects thereof also apply to the apparatus embodiment, which are not described herein any further.

As known from the above technical solutions, this embodiment of the present application achieves the following beneficial effects:

With the startup apparatus for the virtual machine according to this embodiment of the present application, the energy acquiring unit 41 acquires a current energy state of a smart terminal in response to an instruction for starting up a virtual machine, the configuring unit 42 configures a virtual device list for the virtual machine based on the energy state, and the loading unit 43 loads virtual devices in the virtual device list to support running of the virtual machine, the number and the types of virtual devices to be loaded may be determined based on the current energy state of the smart terminal, energy consumptions caused by loading excessive or large-energy-consuming virtual devices when the energy of the smart terminal shrinks, and the smart terminal is ensured to still support running of the smart terminal in an energy shrinking state.

FIG. 5 is a schematic structural diagram illustrating hardware of a smart terminal 500 according to an embodiment of the present application. The smart terminal 500 may be any type of smart terminals, for example, a mobile phone, a tablet computer, a server, a robot or the like, which is capable of performing the startup method for the virtual machine as described above.

Specifically, referring to FIG. 5, the smart terminal 500 includes:

at least one processor 501 and a memory 502, wherein FIG. 5 uses one processor 501 as an example.

The at least one processor 501 and the memory 502 may be connected via a bus or in another manner, and FIG. 5 uses the bus as an example.

The memory 502, as a non-transitory computer-readable storage medium, may be operable to store non-transitory software programs, non-transitory computer-executable programs and modules, for example, the program instructions/modules corresponding to the startup method for the virtual machine according to the embodiments of the present application (for example, the energy acquiring unit 41, the configuring unit 42, the loading unit 43, the energy consumption reference table updating unit 44 and the virtual device list updating unit 45 as illustrated in FIG. 4). The non-transitory software programs, instructions and modules stored in the memory 502, when being executed, cause the processor 501 to perform various function applications and data processing of a smart terminal, that is, performing the startup methods for the virtual machine according to the above method embodiments.

The memory 502 may include a program memory area and data memory area, wherein the program memory area may store operation systems and application programs needed by at least function; and the data memory area may store data created according to the usage of the startup apparatus for the virtual machine. In addition, the memory 502 may include a high speed random access memory, or include a non-transitory memory, for example, at least one disk storage device, a flash memory device, or another non-transitory solid storage device. In some embodiments, the memory 502 optionally includes memories remotely configured relative to the processor 501. These memories may be connected to the smart terminal 500 over a network. Examples of the above network include, but not limited to, the Internet, Intranet, local area network, mobile communication network and a combination thereof.

One or a plurality of modules are stored in the memory 502, and when being executed by the at least one processor 501, perform the startup method for the virtual machine according to any of the above method embodiments, for example, performing steps 110 to 130 in the method as illustrated in FIG. 2 and steps 210 to 250 in the method as illustrated in FIG. 3, and implementing the functions of units 41 to 45 in the apparatus as illustrated in FIG. 4.

An embodiment of the present application further provides a non-volatile computer readable storage medium, wherein the computer readable storage medium stores computer executable instructions, which, when being executed by the at least one processor, for example, the at least one processor 501 as illustrated in FIG. 8, cause the at least one processor 810 to perform the startup method for the virtual machine in any of the above method embodiments, for example, performing steps 110 to 130 in the method as illustrated in FIG. 2 and steps 210 to 250 in the method as illustrated in FIG. 3, and implementing the functions of units 41 to 45 in the apparatus as illustrated in FIG. 4.

The above described system embodiments are merely for illustration purpose only. The units which are described as separate components may be physically separated or may be not physically separated, and the components which are illustrated as units may be or may not be physical units, that is, the components may be located in the same position or may be distributed into a plurality of network units. A part or all of the modules may be selected according to the actual needs to achieve the objectives of the technical solutions of the embodiments.

According to the above embodiments of the present application, a person skilled in the art may clearly understand that the embodiments of the present application may be implemented by means of hardware or by means of software plus a necessary general hardware platform. Persons of ordinary skill in the art may understand that all or part of the steps of the methods in the embodiments may be implemented by a program instructing relevant hardware. The program may be stored in a non-transitory computer-readable storage medium and may be executed by at least one processor. When the program runs, the steps of the methods in the embodiments are performed. The storage medium may be any medium capable of storing program codes, such as read-only, memory (ROM), a random access memory (RAM), a magnetic disk, or a compact disc-read only memory (CD-ROM).

The product may perform the method according to the embodiments of the present application, has corresponding function modules for performing the method, and achieves the corresponding beneficial effects. For technical details that are not illustrated in detail in this embodiment, reference may be made to the description of the methods according to the embodiments of the present application.

Finally, it should be noted that the above embodiments are merely used to illustrate the technical solutions of the present application rather than limiting the technical solutions of the present application. Under the concept of the present application, the technical features of the above embodiments or other different embodiments may be combined, the steps therein may be performed in any sequence, and various variations may be derived in different aspects of the present application, which are not detailed herein for brevity of description. Although the present application is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present application.

What is claimed is:

1. A startup method for a virtual machine, comprising:
at a smart terminal:
acquiring a current energy state of the smart terminal in response to an instruction for starting up the virtual machine;
configuring a virtual device list for the virtual machine based on the energy state; and
loading virtual devices in the virtual device list to support running of the virtual machine.

2. The method according to claim 1, wherein the configuring a virtual device list for the virtual machine based on the energy state comprises:
determining a startup mode of the virtual machine based on the energy state; and
configuring a virtual device list corresponding to the startup mode for the virtual machine.

3. The method according to claim 1, wherein the configuring a virtual device list for the virtual machine based on the energy state comprises:
determining a current upper limit for running the virtual machine based on the energy state;
reading an energy consumption reference table of the virtual machine; and
configuring the virtual device list for the virtual machine based on the current upper limit and the energy consumption reference table.

4. The method according to claim 3, wherein virtual devices in the energy consumption reference table comprise at least one functional virtual device and at least one fundamental virtual device; and
the configuring the virtual device list for the virtual machine based on the current upper limit and the energy consumption reference table comprises:
judging whether the current upper limit is greater than or equal to a sum of current consumption values of all the virtual devices in the energy consumption reference table;
generating the virtual device list with all the virtual devices in the energy consumption reference table if the current upper limit is greater than or equal to the sum of current consumption values of all the virtual devices in the energy consumption reference table; and
otherwise, removing functional virtual devices with a minimum current consumption value in the energy consumption reference table in sequence, until a sum of current consumption values of the remaining virtual devices in the energy consumption reference table is less than or equal to the current upper limit or the remaining virtual devices in the energy consumption reference table are all fundamental virtual devices, such that the virtual device list is generated.

5. The method according to claim 3, further comprising:
collecting statistics for energy consumptions of each of the virtual devices in the process of running the virtual machine; and
updating the energy consumption reference table based on the energy consumptions.

6. The method according to claim 1, wherein when the instruction for starting up the virtual machine comprises an instruction for starting up a particular virtual device, upon the step of configuring the virtual device list for the virtual machine based on the energy state, the method further comprises:
adding the particular virtual device to the virtual device list if the particular virtual device is not in the virtual device list.

7. A smart terminal, comprising:
at least one processor; and
a memory communicably connected to the at least one processor; wherein
the memory stores instructions executable by the at least one processor, wherein, the instructions, when being executed by the at least one processor, cause the at least one processor to perform the method according to claim 1.

8. A non-transitory computer-readable storage medium, wherein the non-transitory computer-readable storage medium stores computer-executable instructions, which, when being executed by a smart terminal, cause the smart terminal to perform the method as defined in claim 1.
